(19) United States
(12) Patent Application Publication
(10) Pub. No.: US 2012/0306785 A1
(43) Pub. Date: Dec. 6, 2012

(54) TOUCH INPUT DEVICE AND ELECTRONIC DEVICE

(75) Inventors: CHIH-WEI CHIEN, Tu-Cheng (TW); ZHAN-YAN WEN, Shenzhen City (CN); XUE-WEI XU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/479,301

(22) Filed: May 24, 2012

(30) Foreign Application Priority Data
Jun. 3, 2011 (CN) 201110149097.9

(51) Int. Cl. G06F 3/041

(52) U.S. Cl. 345/173

(57) ABSTRACT

A touch input device includes a touch pad, two switches, and a supporting member. The supporting member divides the touch pad into a first cantilever part and a second cantilever part. The first cantilever part is capable of moving to activate one of the switches to generate input commands while the second cantilever part moves away from the other one of the switches.

### BACKGROUND

1. Technical Field

The present disclosure relates to input devices, and particularly to a touch input device and an electronic device using the touch input device.

2. Description of Related Art

Touch input devices, such as touch pads, are a common feature of laptop computers. Two buttons equivalent to the left and right buttons on a standard mouse may be positioned beside the touch pad. However, these buttons increases the amount of real estate occupied by the touch input device.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of an electronic device with a touch input device.

FIG. 2 is an isometric view of the touch input device in FIG. 1.

FIG. 3 is exploded view of the touch input device in FIG. 2.

FIG. 4 is exploded view of the touch input device of FIG. 3 viewed from the bottom.

FIG. 5 is a cross-sectional view taken along the line V-V of FIG. 1.

### DETAILED DESCRIPTION

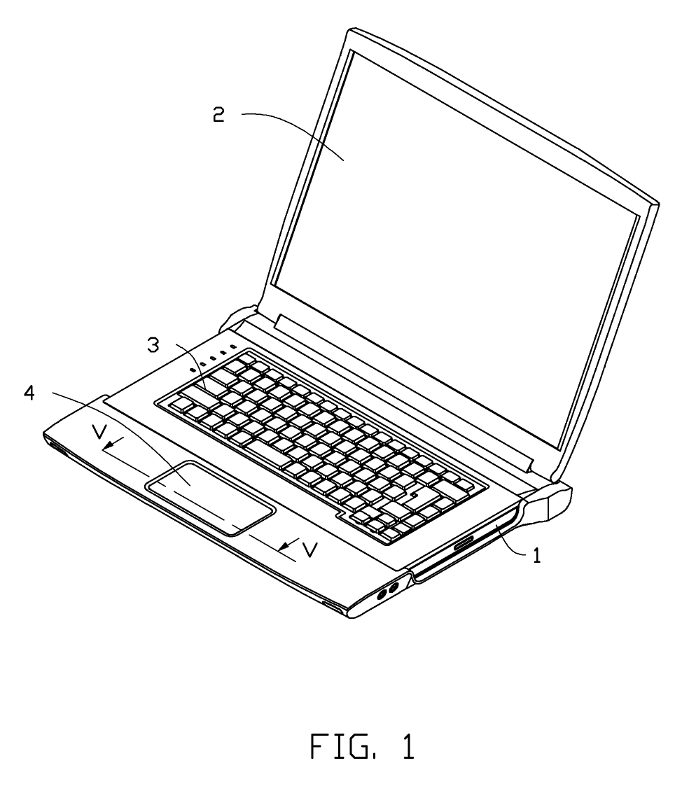

FIG. 1 shows an electronic apparatus including a main body 1, and a cover 2 rotatably coupled to the main body 1. A keyboard 3 and a touch input device 4 are both positioned on the main body 1. The cover 2 is coupled to the backside of the main body 1, the touch input device 4 is adjacent to the front of the main body 1. The keyboard 3 is positioned between the back side and the touch input device 4. The electronic apparatus may be a notebook computer, an electronic book, or a PDA, for example. In this embodiment, the notebook computer is used as an example, and the main body 1 houses the motherboard and other components of the notebook computer, and the cover 2 functions as the display of the notebook computer.

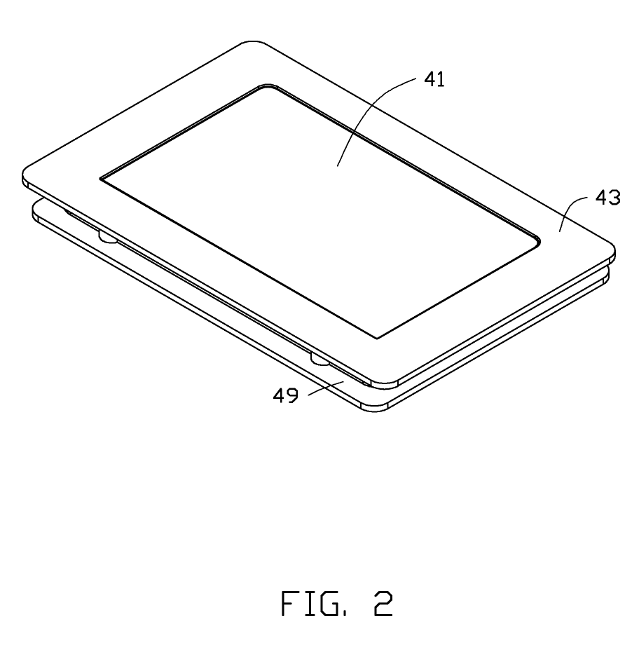

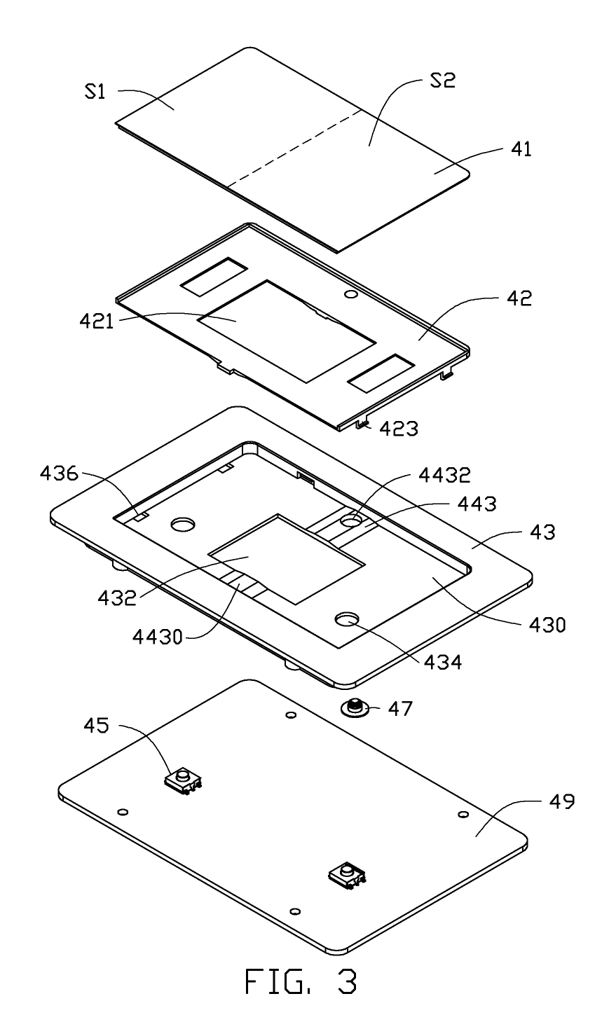

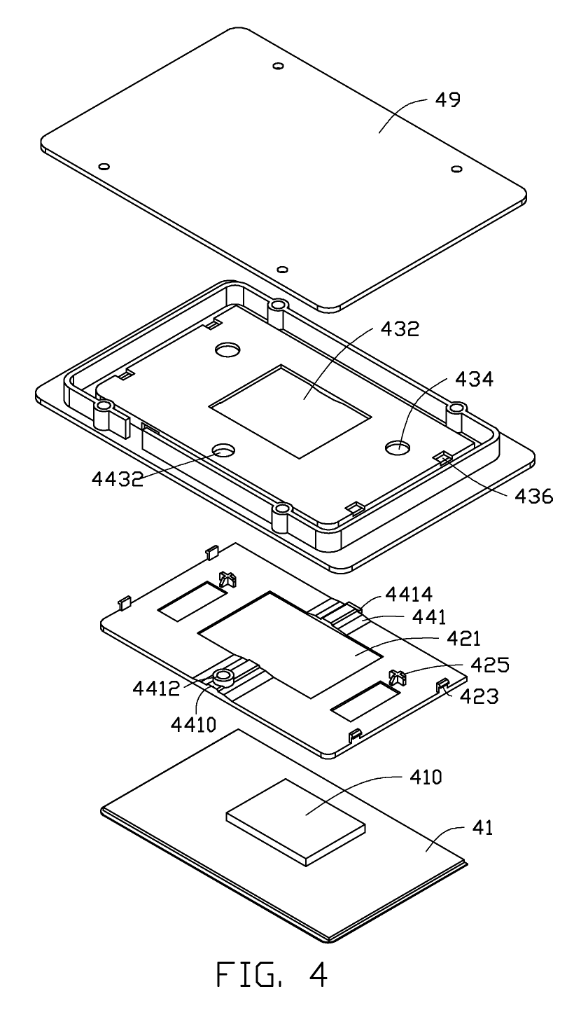

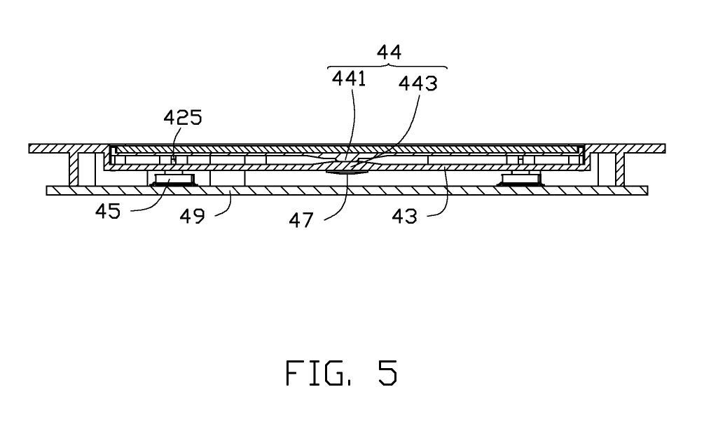

In FIGS. 2-5, the touch input device 4 includes a touch pad 41, a bracket 42, a holding member 43, a supporting member 44, a base board 49, and two switches 45. The touch pad 41 is mounted on the holding member 43 by the bracket 42. The supporting member 44 is placed between the bracket 42 and the holding member 43. The two switches 45 are placed on the base board 49 and under the holding member 43, and the two switches 45 are capable of being actuated by the touch pad 41.

The touch pad 41 is a rectangular board. The top surface of the touch pad 41 extends out of main body 1, so a user can touch it with fingers or a stylus, where the touch pad 41 can translate the touches on the top surface into input commands The bottom surface of the touch pad 41 sits on a circuit board 410. The circuit board 410 is positioned in the middle of the touch pad 41. The circuit board 410 creates and allows particular functions of the touch pad 41.

The bracket 42 is a rectangular board which substantially matches the area of the touch pad 41. The top surface of the bracket 42 is attached to the bottom surface of the touch pad 41. The bracket 42 defines a first opening 421. The first opening 421 is in the center of the bracket 42. The circuit board 410 is accessible through the bracket 42 via the first opening 421. A plurality of hooks 423 and two actuators 425 protrude from the bottom surface of the bracket 42. The plurality of the hooks 423 are arranged on opposite sides of the bracket 42, such as on the left edge and on the right edge. The two actuators 425 are symmetrically positioned on opposite sides of the first opening 421, and are adjacent to hooks 423. Each actuator 425 has the framework of a button or buffer.

The holding member 43 is a rectangular board. The holding member 43 defines a receiving recess 430 which is recessed downwards from the center of the top surface of the holding member 43. The bottom of the receiving recess 430 defines a plurality of clasping holes 436, a second opening 432, and two through holes 434. The clasping holes 436 are positioned on the edges of the bottom of the receiving recess 430. The second opening 432 is positioned in the center of the receiving recess 430. The two through holes 434 are positioned on opposite sides of the second opening 432. The bracket 42 and the touch pad 41 are received in the receiving recess 430 in that order. The hooks 423 are inserted into the clasping holes 436, the touch pad 41 is thus mounted in the receiving recess 430. The circuit board 410 is positioned in the second opening 432. The two actuators 425 are received in the two through holes 434, and are capable of protruding through the two through holes 434.

The supporting member 44 includes a first convex stage 441 protruding from the bracket 42, and a second convex stage 443 protruding from the holding member 43. The first convex stage 441 is along a center line of the bracket 42, the center line of the bracket 42 is between the two actuators 425. The first convex stage 441 has a first engaging surface 4410 away from the bracket 42. The first engaging surface 4410 is a flat strip that runs from one side to the other of the first convex stage 441. A first fixing member 4412 vertically protrudes from the first engaging surface 4410 and is adjacent to one end of the first stage 441. A second fixing member 4414 horizontally protrudes from the first convex stage 441, and away from the first fixing member 4412. The first convex stage 441 divides the bracket 42 into two symmetrical parts, each part having one actuator 425, and the two cantilever seesaw (that is, have a slight clearance distance away from the bottom surface of the first convex stage 441). The touch pad 41 is also symmetrically divided into a first cantilever part S1 and a second cantilever part S2. The first cantilever part S1 and the second cantilever part S2 float in opposite directions with respect to the first convex stage 441 at any one time. For example, on the teeter-totter principle, if one of the first cantilever part S1 and the second cantilever part S2 moves a slight distance away from the first engaging surface 4410, the other one of the first cantilever part S1 and the second cantilever part S2 moves a slight distance towards the first engaging surface 4410.

The second convex stage 443 is along the center line of the receiving recess 430. The second convex stage 443 has a second engaging surface 4430 which matches the first engaging surface 4410. The second convex stage 443 defines a fixing hole 4432. A fixing member 47 such as a screw can pass through the fixing hole 4432 and engage in the fixing member 4412. The second fixing member 4414 is inserted into the holding member 43. The first engaging surface 4410 contacts the second engaging surface 4430. As a result the first convex stage 441 is prevented from falling off the second convex stage 443, the first cantilever part S1 and the second cantilever part S2 can move in opposite directions with respect to the second convex stage 443 at the same time.

The base board 49 is a rectangular board. The two switches 450 are positioned at equal intervals on the top surface of the base board 49. The holding member 43 is placed on the top surface of the base board 49, and one switch 45 is under the first cantilever part S1 and the other switch is under the second cantilever part S2. The two switches 45 are separated from the actuators 425, and one or other of the two switches 45 is capable of being activated by one of the actuators 425 when the first cantilever part S1 or the second cantilever part S2 is pressed.

In operation, a user presses either the first cantilever part S1 or the second cantilever part S2 of the touch pad 41, causing the other cantilever part which has not been pressed to move up. One of the switches 45 is activated by the actuator 425 moving down. At this time, the switch 45 which has been activated inputs the user command. When the pressure on the touch pad 41 is released, the touch pad 41 returns to the original state, the actuator 425 lifts away from the switch 45.

As described above, the supporting member 44 divides the touch pad 41 into a first cantilever part S1 and a second cantilever part S2 which cannot function at the same time. Either the first cantilever part S1 or the second cantilever part S2 may be pressed, to activate one or other of two switches 45, to mimic the behavior of the mouse buttons.

It is to be understood, however, that even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A touch input device, comprising:
a touch pad;
two switches; and
a supporting member to support the touch pad to divide the touch pad into a first cantilever part and a second cantilever part;
wherein one of the first and second cantilever parts is capable of moving to activate one of the switches to generate input commands while the other one of the first and the second cantilever parts moves away from the other one of the switches.

2. The touch input device of claim 1, further comprising a bracket, the bracket being secured on the underside of the touch pad, the bracket member comprising two actuators corresponding to the two switches, the first cantilever part and the second cantilever part activating the switches via the actuators.

3. The touch input device of claim 2, further comprising a holding member, the bracket being coupled to the holding member, the supporting member being positioned between the bracket and the holding member, one of the actuators being capable of passing out of the holding member to activate one of the switches at any one time.

4. The touch input device of claim 3, wherein the supporting member comprises a first convex stage protruding from the bracket, the first convex stage comprises a first engaging surface away from the bracket, the first engaging surface is a flat strip that runs from one side to the other of the first convex stage and contacts the holding member.

5. The touch input device of claim 3, wherein the supporting member comprising a second convex stage protruding from the holding member, the second convex stage comprises a second engaging surface away from the holding member, the second engaging surface is a flat strip that runs from one side to the other of the second convex stage and supports the bracket.

6. The touch input device of claim 3, wherein the supporting member comprises a first and a second convex stages, the first convex stage protrudes from the bracket and comprises a first engaging surface, the second convex stage protrudes from the holding member and comprises a second engaging surface, the first and the second engaging surfaces are flat strips each of which runs from one side to the other of the first convex stage or the second convex stage, and the first engaging surface contacts the second engaging surface.

7. The touch input device of claim 6, wherein the supporting member further comprises a fixing member, the fixing member joins the first convex stage and the second stage to prevent the first engaging surface falling off the second engaging surface.

8. An electronic device comprising:
a housing; and
a touch input device received in the housing; the touch input device comprising:
a touch pad having a top surface extending out of the housing;
two switches; and
a supporting member to support the touch pad to divide the touch pad into a first cantilever part and a second cantilever part;
wherein one of the first and the second cantilever parts is capable of moving in an direction to activate one switch and at the same time the other one of the second cantilever parts is capable of moving in an opposite direction to move away from the other switch when a pressure is exerted on the one of first and the second cantilever part.

9. The electronic device of claim 8, further comprising a bracket, the bracket being secured on the underside of the touch pad, the bracket member comprising two actuators according to the two switches, the first cantilever part and the second cantilever part activating switches via the actuators.

10. The electronic device of claim 9, further comprising a holding member, the bracket is coupled to the holding member, the supporting member being positioned between the bracket and the holding member, and the first cantilever part and the second cantilever part being capable of moving in opposite directions with respect to the holding member, one of the actuators being capable of passing through an opening of the holding member to activate one of the switches at one time.

11. The electronic device of claim 10, wherein the supporting member comprises a first convex stage protruding from the bracket, the first convex stage comprises a first engaging surface away from the bracket, the first engaging surface is a flat strip that runs from one side to the other of the first convex stage and contacts the holding member.

12. The electronic device of claim 11, wherein the supporting member comprising a second convex stage protruding from the holding member, the second convex stage comprises a second engaging surface away from the holding member, the second engaging surface is a is a flat strip that runs from one side to the other of the second convex stage and supports the bracket.

13. The electronic device of claim 11, wherein the supporting member comprises a first and a second convex stages, the first convex stage protrudes from the bracket and comprises a first engaging surface, the second convex stage protrudes from the holding member and comprises a second engaging surface, the first and the second engaging surfaces are flat strips each of which runs from one side to the other of the first convex stage or the second convex stage, and the first engaging surface contacts the second engaging surface.

14. A touch input device comprising:
a touch pad;
a bracket attached to the underside of touch pad a first switch; and
a supporting member protruding from the bracket to divide the touch pad into a first cantilever part and a second cantilever part;
wherein the first and the second cantilever parts are capable of moving in opposite directions with respect to the supporting member, one of the first and the second cantilever parts is capable of moving to activate the first switch when a pressure is exerted on the one of first and the second cantilever part.

15. The touch input device of claim 14, further comprising a second switch, the other one of the first and the second cantilever parts being capable of moving to and away from the second switch while the one of the first and the second cantilever parts moves away from and to the first switch.

16. The touch input device of claim 15, further comprising a holding member, the holding member is coupled to the touch bracket, the supporting member being positioned between the bracket and the holding member, the first and the second cantilever parts moving with respect to the holding member.

17. The touch input device of claim 15, wherein the bracket member comprising two actuators corresponding to the first switch and the second switch, the first cantilever part and the second cantilever part activating the first switch and the second switch via the actuators.

18. The touch input device of claim 17, wherein the actuators being capable of passing through an opening of the holding member to activate the first switch and the second switch.

19. The touch input device of claim 18, wherein the actuators are separated from the first switch and the second switch when there is no pressure is exerted on the touch pad.

20. The touch input device of claim 14, wherein the supporting member supports in the middle of the touch part thus the first and the second cantilever part are symmetrical.
